(19) United States
(12) Patent Application Publication
(10) Pub. No.: US 2005/0078111 A1
(43) Pub. Date: Apr. 14, 2005

(54) Data visualisation system and method

(76) Inventors: Andrew J. Cardno, Wellington (NZ); Andreas Mahn, Wellington (NZ); Craig I. Soper, Wellington (NZ); Warren M. Smith, Wellington (NZ)

Correspondence Address: David E. Bruhn;DORSEY & WHITNEY LLP, Suite 1500, 50 South Sixth Street, Minneapolis, MN, 55402-1498, US

(21) Appl. No.: 10/637,800

(22) Filed: Aug. 8, 2003

Related U.S. Application Data
(63) Continuation of application No. 10/328,718, filed on Dec. 23, 2002, now abandoned.
Application No. 10/328,718 is a continuation of application No. PCT/NZ01/00135, filed on Jul. 5, 2001.

(30) Foreign Application Priority Data
Jul. 5, 2000 (NZ) 505591
May 15, 2001 (NZ) 511734

(51) Int. Cl. G06T 11/20

(52) U.S. Cl. 345/440

(57) ABSTRACT

A data visualisation system including a data value memory in which is maintained a finite set of data values, each data value having a corresponding time value, a display arranged to display a representation of each data value centered on respective data points, the position of each data point based on the time value of each data point, and a contour generator arranged to generate and display a contoured representation around each data point such that each data point is displayed as a local maximum. The invention encompasses a data visualisation method and program.

### FIELD OF INVENTION

The invention relates to a data visualisation system and method.

### BACKGROUND TO INVENTION

The low cost of data storage hardware has led to the collection of large volumes of data. Broadcasters who operate mass media for example television, radio and newspapers generate and collect large volumes of data during the course of their business. To compete effectively, it is necessary for such broadcasters to be able to identify and use information hidden in the collected data. It would be helpful for a broadcaster to know its audience better to enable enhanced placement of advertisements. Better knowledge of the viewing trends and viewer profiles would enable the broadcaster to charge increased fees for advertisements targeted at certain audiences. The task of identifying this hidden information has proved very difficult for these broadcasters.

Traditionally, analysis of data has been achieved by running a query on a set of data records stored in a database. The merchant or other party first creates a hypothesis, converts this hypothesis to a query, runs the query on the database, and interprets the results obtained with resect to the original hypothesis.

One disadvantage of this verification driven hypothesis approach is that the merchant must form the desired hypothesis in advance. This is merely confirming what the merchant already suspects and does not provide the merchant with information which may be unexpected. Another disadvantage is that the merchant needs to have available the technical knowledge to formulate the appropriate queries.

Our patent specification WO 00/77682 to Compudigm International Limited entitled “Data Visualisation System and Method” describes a system and method of presenting visualisations in an intuitive manner for various types of merchants. It would be particularly desirable to include data such as the time of various transactions and interactions to enhance the effectiveness and visual appeal of these visualisations.

### SUMMARY OF INVENTION

In broad terms in one form the invention comprises a data visualisation system comprising a data value memory in which is maintained a finite set of data values, each data value having a corresponding time value; a display arranged to display a representation of each data value centered on respective data points, the position of each data point based on the time value of each data point; and a contour generator arranged to generate and display a contoured representation around each data point such that each data point is displayed as a local maximum.

In another form in broad terms the invention comprises a data visualisation system comprising a data value memory in which is maintained a finite set of data values, each data value having a corresponding time value; a display arranged to display a representation of each data value centered on respective data points, the position of each data point based on the time value of each data point; and a contour generator arranged to generate and display one or more contour lines around each data point, each contour line representing data values which are less than the data value of the data point around which the contour line is displayed.

In another preferred form the invention comprises a method of data visualisation comprising the steps of maintaining a data value memory a finite set of data values, each data value having a corresponding time value; displaying a representation of each data value centered on respective data points, the position of each data point based on the time value of each data point; and generating and displaying a contoured representation around each data point such that each data point is displayed as a local maximum.

In another preferred form the invention comprises a method of data visualisation comprising the steps of maintaining in a data value memory a finite set of data values, each data value having a corresponding time value; displaying a representation of each data value centered on respective data points, the position of each data point based on the time value of each data point; and generating and displaying one or more contour lines around each data point, each contour line representing data values which are less than the data value of the data point around which the contour line is displayed.

In a further preferred form the invention comprises a data visualisation computer program which enables maintaining in a data value memory a finite set of data values, each data value having a corresponding time value; displaying a representation of each data value centered on respective data points, the position of each data point based on the time value of each data point, and generating and displaying a contoured representation around each data point such that each data point is displayed as a local maximum.

In yet another preferred form the invention comprises a data visualisation computer program which enables maintaining in a data value memory a finite set of data values, each data value having a corresponding time value; displaying a representation of each data value centered on respective data points, the position of each data point based on the time value of each data point; and generating and displaying one or more contour lines around each data point, each contour line representing data values which are less than the data value of the data point around which the contour line is displayed.

### BRIEF DESCRIPTION OF THE FIGURES

Preferred forms of the data visualisation system and method will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 is a flowchart of a preferred form of the invention;

FIG. 4 is a preferred linear representation generated in accordance with the invention;

FIG. 5 is a preferred circular representation generated in accordance with the invention;

FIG. 6 is a further preferred circular representation generated with the invention;

FIG. 7 is a further preferred spiral representation; and

FIGS. 8 and 9 are further preferred form spiral representations generated by the invention.

### DETAILED DESCRIPTION OF PREFERRED FORMS

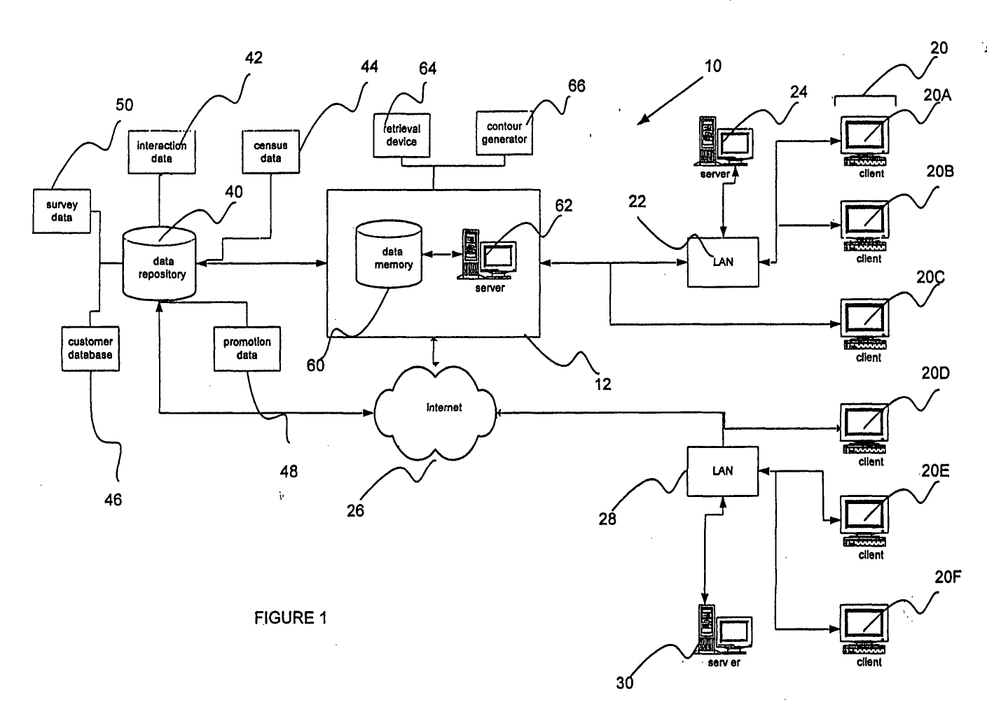

FIG. 1 illustrates a block diagram of the preferred system 10 in which one form of the present invention may be implemented. The system includes one or more clients 20, for example 20A, 20B, 20C, 20D, 20E and 20F, which each may comprise a personal computer or workstation described below. Each client 20 is interfaced to a workstation 12 as shown in FIG. 1. Each client 20 could be connected directly to the workstation, could be connected through a local area network or LAN, or could be connected through the Internet.

Clients 20A and 20B, for example, are connected to a network 22, such as a local area network or LAN. The network 22 could be connected to a suitable network server 24 and communicate with the workstation as shown. Client 20C is shown connected directly to the workstation using for example a serial connection or WAP connection. Clients 20D, 20E and 20F are shown connected to the workstation through the Internet 26. Client 20D is shown as connected to the Internet 26 with a dial-up connection and clients 20E and 20F are shown connected to a network 28 such as a local area network or LAN, with the network 28 connected to a suitable network server 30.

The preferred system 10 further comprises a data repository 40, for example a data warehouse maintained in a memory. It is envisaged that the data repository may alternatively comprise a single database, a collection of databases, or a datamart. The preferred data repository 40 includes data from a variety of sources. The data repository may include, for example, interaction data 42 representing interactions between customers and merchants, as will be more particularly described below. The data repository may also include data from other sources for example census data 44, data from merchant customer databases 46, promotion data 48 held by a merchant or other organisation, and/or survey data 50 resulting from customer surveys.

The personal computer or workstation 12 preferably operates under the control of appropriate operating and application software, and has a data memory 60 connected to a server 62. The invention includes a retrieval device 64 which in one form comprises a software implemented query enabling retrieval of data from the data repository 40. The data retrieved using the retrieval device 64 is processed with the server 62. A contour generator 66 which in one form comprises a computer-implemented software program generates a contoured representation or series of contour lines in order to display a representation of the data on a client workstation 20, as will be described below.

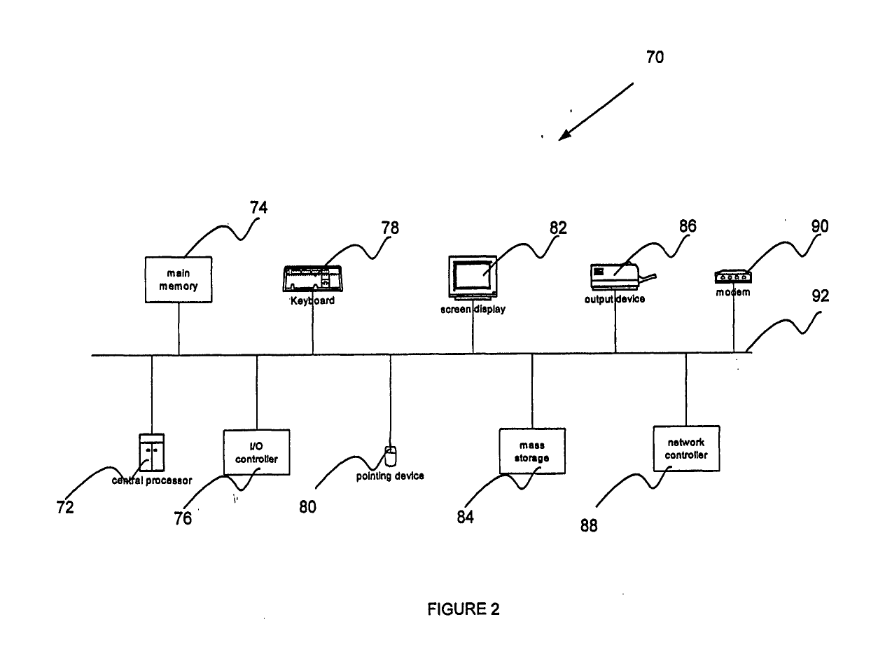

FIG. 2 shows the preferred system architecture of a client 20 or workstation 12. The computer system 70 typically comprises a central processor 72, a main memory 74 for example RAM and an input/output controller 76. The computer system 70 also comprises peripherals such as a keyboard 78, a pointing device 80 for example a mouse, track ball or touch pad, a display or screen device 82, a mass storage memory 84 for example a hard disk, floppy disk or optical disc, and an output device 86 for example a printer. The system 70 could also include a network interface card or controller 88 and/or a modem 90. The individual components of the system 70 could communicate through a system bus 92.

Typically a merchant will transmit programmes, information and/or data to one or more customers over mass media, for example television, radio or newspapers. The merchant, for example, may operate a private television network in which customers pay the merchant to receive a transmission. In one example, the merchant may provide the customer with identification apparatus for example a decoder which enables a particular customer to receive a data transmission. The apparatus records the customer identifier and the channel and time during which transmission is requested.

As the customer interacts with the merchant in this way, the interaction generates interaction data which is then migrated to the data repository 40. The interaction data could be stored in a number of records in a relational database. Each record may include a merchant identifier used to identify a particular merchant and a date and/or time at which the interaction between the customer and merchant took place.

The record could also include a customer identifier. The decoder preferably has stored on it a customer identifier and may have stored other data, for example residential address and family size of the customer. Such data is typically stored in a customer database 46 and could be migrated to the data repository 40.

The merchant may also provide selected customers with apparatus which records viewing habits. The viewing habits of this sample group of customers could be recorded and stored in a database, together with appropriate demographic data. This sample customer database could be made available to other merchants in order to estimate population viewing habits.

The interaction data is migrated to the data repository 40, generally by way of daily updates or in real time. It is advantageous to cleanse, catalogue and validate the interaction data during migration of the data to the data repository, and this task could be performed by either the merchant or by a third party. Once stored in the data repository 40, the data could be linked to other sources of data for subsequent retrieval, for example the census data 44, data from the merchant customer database 46, promotion data 48 and/or survey data 50 held by the merchant.

The data repository 40 could be maintained by a merchant or alternatively could be maintained by a third party. Updates to the data repository could be carried out by the merchant directly, or alternatively the merchant could provide batched data to a third party for updating the data. Alternatively, a third party could be entrusted with the task of collecting the interaction data and migrating the data to the data repository.

Preferred forms of the invention are arranged to display various key performance indicators or KPIs for a merchant. The KPI, for example the number of viewers, is preferably graphically represented adjacent or near to a representation of the channel and time segment viewed by the customer. There are a finite number of time slots and channels in mass media and the individual audiences for each time slot represent a finite set of data values. These data values are preferably graphically illustrated as data points on the representation.

The preferred representation is coloured and the value of revenue of each machine is illustrated by representing the corresponding data points in the appropriate colour to represent the correct KPI value for each time segment.

The areas of the representation around each data point are shown as a series of contour lines. The nature of the contours for each data point are preferably represented to gradually drop off or fall away from each data point. Each data point could be represented by x and y co-ordinates indicating the relevant position of each data point in the representation. Each data point could also have a z value representing the height or magnitude of the data point. This z value could indicate, for example, the revenue from viewers, number of viewers or other data value in a particular data point. The contour lines represent z data values which are less than the data value of the data point around which the contour lines are displayed. In this way, each data value is centered on a data point. Each data point is displayed as a local maximum as surrounding values drop off or fall away around each point.

This contoured method of representing data values is more particularly described in our patent specification WO 00/77862 to Compudigm International Limited filed on 14 Jun. 2000 entitled “Data visualisation system and method” which is incorporated by reference. The data value of each data point represents the apex of a bell-shaped curve. As x and y values in the representation 100 are increased or decreased, the z value at the new position in the representation will change.

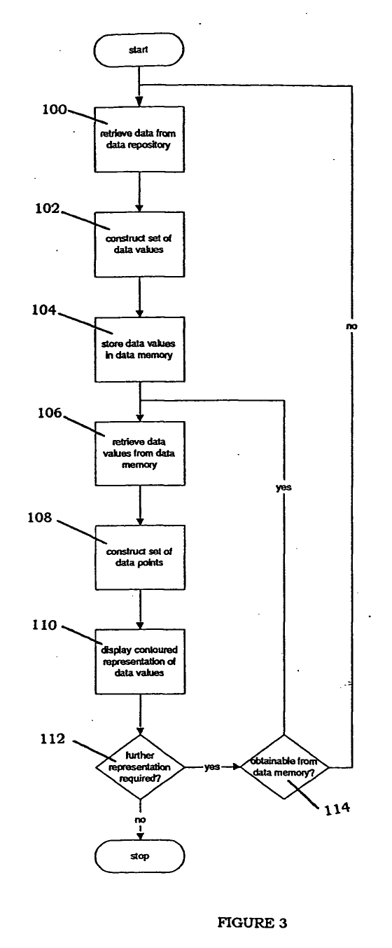

FIG. 3 illustrates the preferred method of operation of the invention. As shown at 100, data is retrieved from the data repository 40 using a suitable query by the retrieval device 64. The retrieved data could include data representing interactions between customers and merchants, where this data is stored in the data repository 40. The retrieved data could include the number of viewers watching a particular television channel over a specified time interval, the numbers of views of a certain category (eg: 18-25 year males), or any other key performance indicator or KPI.

As shown at 102, a set of data values is constructed from the retrieved data. This set of data values could include, for example, the number of viewers watching one channel during a one hour time segment. It is envisaged that the set of data values could be stored in data value memory 60 to increase efficiency of the system as indicated at 104. The data value memory could comprise volatile main RAM or non-volatile mass storage of the workstation on which the invention 12 is implemented.

Referring to step 106, the set of data values are retrieved from the volatile or non-volatile data memory and as shown at 108, a set of data points is constructed to represent the data values. Appropriate x and y values are generated for each data point to space the data points over a generated representation. Each data point has a corresponding time value and the x and y values are based on this time value. Z values for each data point are also calculated based on individual data values.

Referring to step 110, a contoured representation of the data values is generated by the contour generator 66 and displayed on a client workstation 20. The individual drop-off for each data point is calculated and displayed in the appropriate colour and shading corresponding to the z value at each point.

It is envisaged that the invention generate individual displays of contoured representations. It is also envisaged that the invention generate animated sequences of representations by generating two or more “still” representations at various time intervals and superimposing successive representations over earlier representations to generate an animated sequence m which a succession of data points appear to move on a display.

As indicated at 112, where such an animated sequence is required, further representations will be needed and if the necessary data is obtainable from the data memory as indicated at 114, it is retrieved from the data memory as indicated at 106, otherwise further data is retrieved from the data repository at 100.

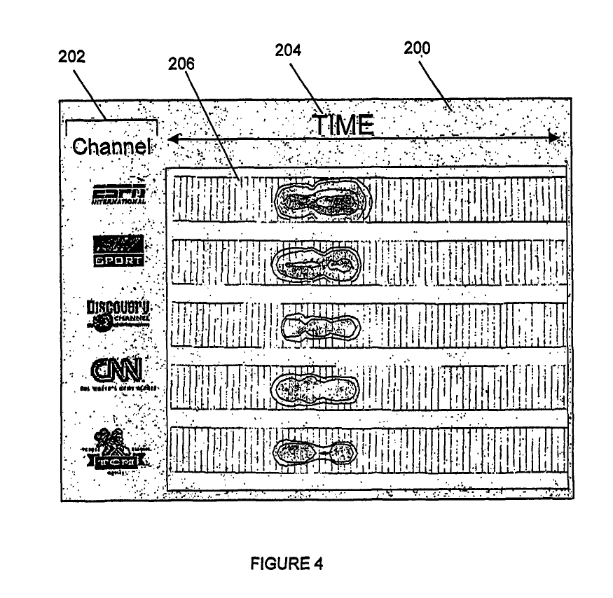

Referring to FIG. 4, a graphical representation 200 of a merchant is generated and is displayed on the screen display of a client workstation 20. The representation 200 could include a series of channels operated by the merchant indicated at 202. The representation could also include a time period as indicated at 204.

The representation could include a series of time segments, one of which is indicated at 206. These time segments could represent, for example, fifteen-minute time segments of data transmission. Each segment is preferably colour-coded and the same colour could be used for similar categories which appear at different times during the day, for example breakfast news and prime time news.

The representation 200 preferably also includes one or more contoured representations, for example the contoured representation indicated at 208. Each contoured representation comprises a series of data points, each data point centered on a time segment. Data values, for example the number of customers watching the channel during that time segment, are shown as a contoured representation around the time segment.

The representation of FIG. 4 shows a contoured representation of the number of customers watching each channel during a pre-specified time period involving several time segments.

Where the representation is animated, the segments over which representations are contoured could be shifted left or right to indicate progressive or historic time segments. In the case of FIG. 4, the x, y values of each data point are generated in order to display a series of data points in a linear arrangement. FIG. 4 shows a series of data points, each with contoured representations around each data point, travelling from left to right in a linear path across a display.

It is assumed that the time period of interest commences at point tₚ and ends at point t₀. Each point travels from a leftmost minimum value Xₘᵢₙ to a rightmost or maximum value Xₘₐₓ.

The display could calculate the position of each data point as a function of time t as follows:

$$x ( t ) = {x}_{min} + ( {x}_{max} - {x}_{min} ) ( \frac{t - {t}_{p}}{{t}_{0} - {t}_{p}} ) \qquad ( 1 )$$

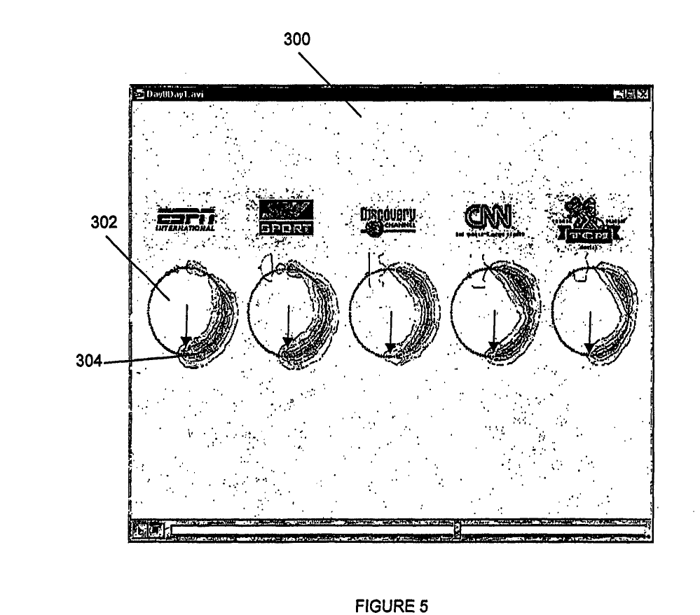

FIG. 5 illustrates a further preferred form representation 300 in which each channel is represented as a clock or circle, for example 302. Each image represents the number of viewers watching a particular channel during a particular time period. A contoured representation of these viewers indicated at 304 is preferably centered on a series of data points around the circle, where each data point is positioned on the circumference of the circle to represent respective time segments.

Where an animated sequence is presented to a user, the data points could be repositioned in a circular arrangement around the circle to represent changing time periods, with representations centred on the successive data points. This would have the effect of the contoured representation proceeding around the clock to represent the passage of time. The size and colour of the contours would represent the characteristics or KPIs demonstrated by the system.

It is assumed that the time period of interest commences at tₚ and ends at t₀, and that t₀−tₚ<T. Each circle 302 comprises a series of data points around a “clock face” where one revolution represents time T. The current time t moves around the clock representing an angle calculated by the following function:

$$angle = \frac{2 π t}{T} \qquad ( 2 )$$

The x and y values for each data point are calculated based on the angle calculated from equation (2). If t₀−tₚ>T, or for a continuously changing system, previous values are overwritten during each revolution of the circle 302.

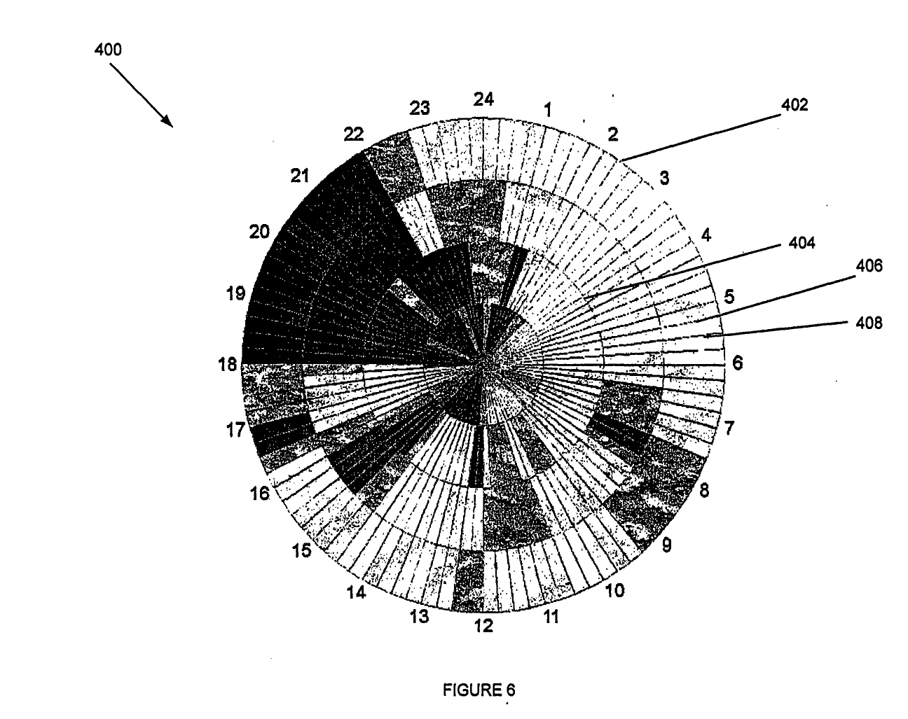

FIG. 6 illustrates a further representation 400 which could be generated by the invention. The representation 400 comprises a series of concentric circles, for example 402 and 404. Each circle is divided into a series of time segments by a series of radial lines, for example 406 and 408, each time segment representing a specified period of 15 minutes.

The areas defined by the circles and radial lines could be shaded a different colour to represent for example different numbers of viewers or different types of viewer profile, for example men aged 25 to 40.

In one form the rings could represent the current date and time, the same time one week ago and the same time two weeks ago. Alternatively, the rings could represent different types of programmes, for examples movies, sport and news. As a further example, each ring could represent different viewer profiles for example viewers aged 50 years and over, viewers aged 25 to 29 and viewers aged less than 25.

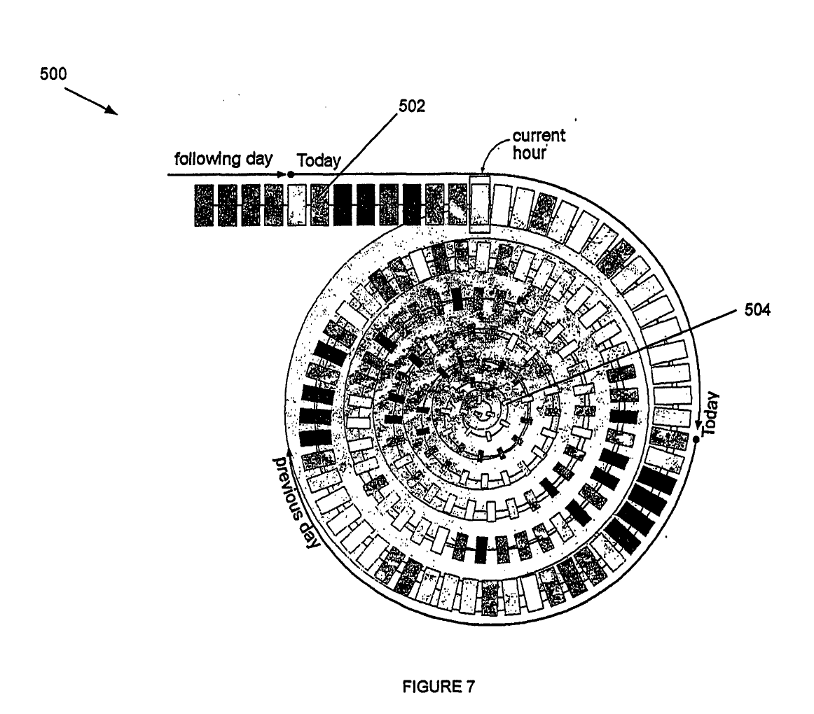

FIG. 7 illustrates an alternative to concentric rings. Representation 500 comprises a spiral in which recent time segments, for example 502, are more visible than less recent time segments, for example 504. Each data point, for example the data point representing time segment 502 or 504 has an x and y coordinate, the position of which is based on the time value of each data point. The data points are displayed as a series of representations in a spiral arrangement. The spiral covers data in a time sequence from a recent time tₚ back to t₀.

The value r₀ is the maximum radius of the spiral. The position of a data point at time t in polar coordinates is:
p(t)=(r(t),theta(t)) (3)
The radius for a time period in a previous time period rT could be for example rT=0.8 r₀. The position of the data point for time t in polar coordinates, is found by equation (3) above.

Theta (t) is calculated by the following equation:

$$theta ( t ) = \frac{- 2 π ( {t}_{0} - t )}{T} \qquad ( 4 )$$

The radius at time t, r(t) is calculated by the following equation:

$$r ( t ) = {r}_{0} {exp}^{-} \{ \frac{rT ( {t}_{0} - t )}{{r}_{0} T} \} \qquad ( 5 )$$

It is envisaged that, once the data points are generated, these data points can be contoured as described above.

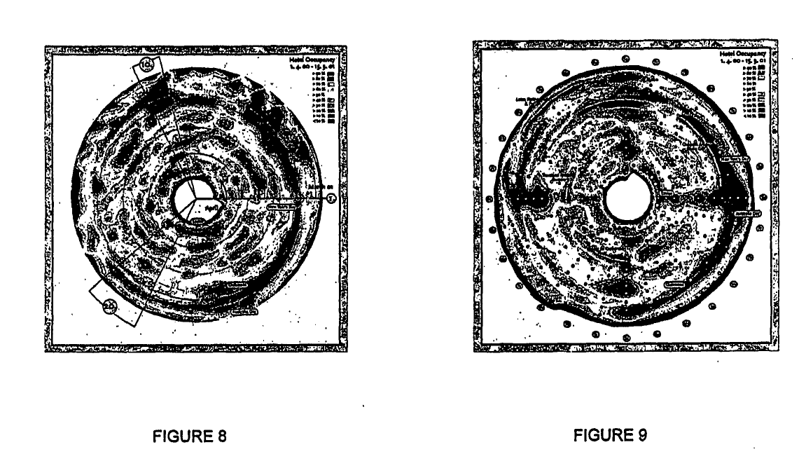

Referring to FIG. 8, the invention could generate and display data points in a spiral of fixed spacing. A spiral could be generated showing any given period, for example a year, which could be separated into different sub-periods, for example individual days. Over these segments could be contoured data revealing activity during the entire period. The most recent sub-periods could be presented in detail on the outer extremity of the spiral alongside the earliest shown in the summary form in the center of the spiral.

The invention displays data during a time period from tₚ to t₀, where t₀−tₚ>T. The invention enables a time t to be compared with t−T, t−2T, t−3T and so on. The value r₀ is the maximum radius of the spiral and rₘᵢₙ is the minimum viewable radius of the spiral, approximately

$$\frac{{r}_{0}}{4} .$$

The position of the data point for time t in polar coordinates, is p(t) calculated from equation (3) above and theta (t) is calculated from equation (4) above.

The radius at time t, r(t) is calculated by the following equation:

$$r ( t ) = {r}_{min} + \frac{( {r}_{0} - {r}_{min} ) ( t - {t}_{p} )}{( {t}_{0} - {t}_{p} )} \qquad ( 6 )$$

The invention further provides a method of identifying similar periods of activity and either tightening or loosening time periods represented in a 360° rotation of the spiral so that these are aligned. The spiral of FIG. 8 represents one calendar month per rotation. When this is adjusted to represent a four week period, trends in the data become evident, as is shown in FIG. 9.

It is envisaged that the spiral of FIGS. 8 and 9 could be animated, examples of this could include rotation of the spiral where the most recent entry remains at a fixed point on the outer edge of the spiral, or where the spiral appears to grow around itself as the earlier points are dropped off.

It is envisaged that the flexible displays of the invention based on the time values for individual data points could be applied to many types of interactions. A merchant for example may operate commercial premises or stores from which a customer purchases goods or services. The merchant could operate a petrol station in one or more geographic locations. The merchant could alternatively operate a wagering or betting service, or operate a casino or other gaming facility in which several gaming machines and stations are positioned in one or more common rooms at a common venue. The merchant could also operate a warehouse facility, manufacturing facility, car parking premises, telecommunications network or website. The merchant could also offer a range of financial or insurance services. The merchant could operate a warehouse or could provide telecommunications services.

The foregoing describes the invention including preferred forms thereof. Alterations and modifications as will be obvious to those skilled in the art are intended to be incorporated within the scope hereof as defined by the accompanying claims.

1-22. (canceled)

23. A data visualisation system comprising:
a data value memory in which is maintained a finite set of data values, each data value having a corresponding time value;
a display arranged to display a representation of each data value centered on respective data points, the position of each data point based on the time value of each data point; and
a contour generator arranged to generate and display a contoured representation around each data point such that each data point is displayed as a local maximum.

24. A data visualisation system as claimed in claim 23 further comprising:
a memory in which is maintained an interaction database of interaction data representing interactions between customers and merchants; and
a retrieval device arranged to retrieve from the interaction database data representing interactions between customers and merchants, to construct the finite set of data values from the retrieved data and to store the data values in the data value memory.

25. A data visualisation system as claimed in claim 23 wherein the display is arranged to display a series of representations of data values during a time interval.

26. A data visualisation system as claimed in claim 25 wherein the display is arranged to display the series of representations in a linear arrangement.

27. A data visualisation system as claimed in claim 25 wherein the display is arranged to display the series of representations in a circular arrangement.

28. A data visualisation system as claimed in claim 25 wherein the display is arranged to display the series of representations in a spiral arrangement.

29. A data visualisation system comprising:
a data value memory in which is maintained a finite set of data values, each data value having a corresponding time value;
a display arranged to display a representation of each data value centered on respective data points, the position of each data point based on the time value of each data point; and
a contour generator arranged to generate and display one or more contour lines around each data point, each contour line representing data values which are less than the data value of the data point around which the contour line is displayed.

30. A data visualisation system as claimed in claim 29 further comprising:
a memory in which is maintained an interaction database of interaction data representing interactions between customers and merchants; and
a retrieval device arranged to retrieve from the interaction database data representing interactions between customers and merchants, to construct the finite set of data values from the retrieved data and to store the data values in the data value memory.

31. A data visualisation system as claimed in claim 29 wherein the display is arranged to display a series of representations of data values during a time interval.

32. A data visualisation system as claimed in claim 31 wherein the display is arranged to display the series of representations in a linear arrangement.

33. A data visualisation system as claimed in claim 31 wherein the display is arranged to display the series of representations in a circular arrangement.

34. A data visualisation system as claimed in claim 31 wherein the display is arranged to display the series of representations in a spiral arrangement.

35. A method of data visualisation comprising the steps of:
maintaining in a data value memory a finite set of data values, each data value having a corresponding time value;
displaying a representation of each data value centered on respective data points, the position of each data point based on the time value of each data point; and
generating and displaying a contoured representation around each data point such that each data point is displayed as a local maximum.

36. A method of data visualisation as claimed in claim 35 further comprising the steps of:
maintaining in a memory an interaction database of interaction data representing interactions between customers and merchants;
retrieving from the interaction database data representing interactions between customers and merchants;
constructing the finite set of data values from the retrieved data, each data value having a corresponding time value; and
storing the data values in the data value memory.

37. A method of data visualisation as claimed in claim 35 further comprising the step of displaying a series of representations of data values during a time interval.

38. A method of data visualisation as claimed in claim 37 further comprising the step of displaying the series of representations in a linear arrangement.

39. A method of data visualisation as claimed in claim 37 further comprising the step of displaying the series of representations in a circular arrangement.

40. A method of data visualisation as claimed in claim 37 further comprising the step of displaying the series of representations in a spiral arrangement.

41. A method of data visualisation comprising the steps of:
maintaining in a data value memory a finite set of data values, each data value having a corresponding time value;
displaying a representation of each data value centered on respective data points, the position of each data point based on the time value of each data point; and
generating and displaying one or more contour lines around each data point, each contour line representing data values which are less than the data value of the data point around which the contour line is displayed.

42. A method of data visualisation as claimed in claim 41 further comprising the steps of:
maintaining in a memory an interaction database of interaction data representing interactions between customers and merchants;
retrieving from the interaction database data representing interactions between customers and merchants;
constructing the finite set of data values from the retrieved data, each data value having a corresponding time value; and
storing the data values in the data value memory.

43. A method of data visualisation as claimed in claim 41 further comprising the step of displaying a series of representations of data values during a time interval.

44. A method of data visualisation as claimed in claim 43 further comprising the step of displaying the series of representations in a linear arrangement.

45. A method of data visualisation as claimed in claim 43 further comprising the step of displaying the series of representations in a circular arrangement.

46. A method of data visualisation as claimed in claim 43 further comprising the step of displaying the series of representations in a spiral arrangement.

47. A data visualisation computer program which enables:
maintaining in a data value memory a finite set of data values, each data value having a corresponding time value;
displaying a representation of each data value centered on respective data points, the position of each data point based on the time value of each data point; and
generating and displaying a contoured representation around each data point such that each data point is displayed as a local maximum.

48. A data visualisation computer program as claimed in claim 47 which further enables:
maintaining in a memory an interaction database of interaction data representing interactions between customers and merchants;
retrieving from the interaction database data representing interactions between customers and merchants;
constructing the finite set of data values from the retrieved data, each data value having a corresponding time value; and
storing the data values in the data value memory.

49. A data visualisation computer program as claimed in claim 47 which further enables displaying a series of representations of data values during a time interval.

50. A data visualisation computer program as claimed in claim 49 which further enables displaying the series of representations in a linear arrangement.

51. A data visualisation computer program as claimed in claim 49 which further enables displaying the series of representations in a circular arrangement.

52. A data visualisation computer program as claimed in claim 49 which further enables displaying the series of representations in a spiral arrangement.

53. A data visualisation computer program which enables:
maintaining in a data value memory a finite set of data values, each data value having a corresponding time value;
displaying a representation of each data value centered on respective data points, the position of each data point based on the time value of each data point; and
generating and displaying one or more contour lines around each data point, each contour line representing data values which are less than the data value of the data point around which the contour line is displayed.

54. A data visualisation computer program as claimed in claim 53 which further enables:
maintaining in a memory an interaction database of interaction data representing interactions between customers and merchants;
retrieving from the interaction database data representing interactions between customers and merchants;
constructing the finite set of data values from the retrieved data, each data value having a corresponding time value; and
storing the data values in the data value memory.

55. A data visualisation computer program as claimed in claim 53 which further enables displaying a series of representations of data values during a time interval.

56. A data visualisation computer program as claimed in claim 55 which further enables displaying the series of representations in a linear arrangement.

57. A data visualisation computer program as claimed in claim 55 which further enables displaying the series of representations in a circular arrangement.

58. A data visualisation computer program as claimed in claim 55 which further enables displaying the series of representations in a spiral arrangement.

59. A data visualisation computer program as claimed in claim 47 embodied on a computer readable medium.

60. A data visualisation computer program as claimed in claim 53 embodied on a computer readable medium.
